(19) United States
(12) Patent Application Publication
(10) Pub. No.: US 2025/0210015 A1
(43) Pub. Date: Jun. 26, 2025

(54) DEVICE, ENSEMBLE SYSTEM, SOUND REPRODUCING METHOD, AND NON-TRANSITORY COMPUTER-READABLE RECORDING MEDIUM

(71) Applicant: YAMAHA CORPORATION, Hamamatsu-shi (JP)

(72) Inventors: Akira MAEZAWA, Hamamatsu-shi (JP); Yoshifumi MIZUNO, Hamamatsu-shi (JP)

(21) Appl. No.: 18/391,861

(22) PCT Filed: Dec. 23, 2023
(86) PCT No.: PCT/JP2021/023765

§ 371 Date: Dec. 21, 2023

(51) Int. Cl. G10H 1/00

(52) U.S. Cl. CPC G10H 1/0008; G10H 2210/091

(57) ABSTRACT

A first device is for a remote ensemble performed in a first venue and a second venue and provided in the first venue. The device includes a memory and an estimation circuit. The memory stores a performance sound estimation model. The estimation circuit inputs, into the performance sound estimation model, a performance sound obtained by a second venue device provided in the second venue to estimate an estimated future performance sound of the performance sound. The performance sound estimation model is a trained model trained to learn a sound signal corresponding to the performance sound to estimate the estimated future performance sound based on the performance sound.

### CROSS-REFERENCE TO RELATED APPLICATIONS

The present application is a continuation application of International Application No. PCT/JP2021/023765, filed Dec. 23, 2023. The contents of this application are incorporated herein by reference in their entirety.

### BACKGROUND

### Field

The present disclosure relates to a first device, an ensemble system, a sound reproducing method, and a non-transitory computer-readable recording medium.

### Background Art

JP 2008-131379 A discloses a system that distributes, live, a moving image of singing performance and/or musical performance. In this system, the singer(s) and musical performer(s) perform at different places. At each of the places, a camera is set. A control center synthesizes moving images obtained from the cameras to generate a distribution moving image, and distributes the distribution moving image to receiving terminals.

In a case where performers are remote from each other, it is necessary for each performer to use a communication line to receive and listen to sounds made by other performers. If sound is transmitted through a communication line, latency in sound transmission might occur, causing a delay between the moment a sound is produced at one performer and the moment the sound is heard at the destination performer. Thus, it has been difficult for remote performers to play in concert in a natural manner.

The present disclosure has been made in view of the above-described and other circumstances, and has an object to reproduce sound with no or minimal delay after receiving the sound through a communication line.

### SUMMARY

One aspect is a first device for a remote ensemble performed in a first venue and a second venue and provided in the first venue. The device includes a memory and an estimation circuit. The memory is configured to store a performance sound estimation model. The estimation circuit is configured to input, into the performance sound estimation model, a performance sound obtained by a second device provided in the second venue to estimate an estimated future performance sound of the performance sound. The performance sound estimation model is a trained model trained to learn a sound signal corresponding to the performance sound to estimate the estimated future performance sound based on the performance sound.

Another aspect is an ensemble system for a remote ensemble performed in a first venue and a second venue. The ensemble system includes a first terminal device and a second terminal device. The first terminal device is provided in the first venue. The second terminal device is provided in the second venue. The first terminal device includes a first memory, a first obtaining circuit, a first transmission circuit, a first reception circuit, a first estimation circuit, and a first sound outputting circuit. The first memory is configured to store a second performance sound estimation model. The first obtaining circuit is configured to obtain a first performance sound generated in the first venue. The first transmission circuit is configured to transmit the first performance sound to the second terminal device. The first reception circuit is configured to receive, from the second terminal device, a second performance sound generated in the second venue. The first estimation circuit is configured to input, into the second performance sound estimation model, the second performance sound received at the first reception circuit to estimate an estimated future second performance sound of the second performance sound. The first sound outputting circuit is configured to output the estimated future second performance sound. The second terminal device includes a second memory, a second obtaining circuit, a second transmission circuit, a second reception circuit, a second estimation circuit, and a second sound outputting circuit. The second memory is configured to store a first performance sound estimation model. The second obtaining circuit is configured to obtain the second performance sound. The second transmission circuit is configured to transmit the second performance sound to the first terminal device. The second reception circuit is configured to receive the first performance sound from the first terminal device. The second estimation circuit is configured to input, into the first performance sound estimation model, the first performance sound received at the second reception circuit to estimate an estimated future first performance sound of the first performance sound. The second sound outputting circuit is configured to output the estimated future first performance sound. The first performance sound estimation model is a trained model trained to learn a first sound signal corresponding to the first performance sound to estimate the estimated future first performance sound based on the first performance sound. The second performance sound estimation model is a trained model trained to learn a second sound signal corresponding to the second performance sound to estimate the estimated future second performance sound based on the second performance sound.

Another aspect is a sound reproducing method performed by a computer that is for a remote ensemble performed in a first venue and a second venue and that is provided in the first venue. The sound reproducing method includes inputting, into a performance sound estimation model, a performance sound obtained by a device provided in the second venue to estimate an estimated future performance sound of the performance sound. The performance sound estimation model is a trained model trained to learn a sound signal corresponding to the performance sound to estimate the estimated future performance sound based on the performance sound.

Another aspect is a non-transitory computer-readable recording medium storing a program that, when executed by at least one computer that is for a remote ensemble performed in a first venue and a second venue and that is provided in the first venue, cause the at least one computer to perform a method including inputting, into a performance sound estimation model, a performance sound obtained by a device provided in the second venue to estimate an estimated future performance sound of the performance sound. The performance sound estimation model is a trained model trained to learn a sound signal corresponding to the performance sound to estimate the estimated future performance sound based on the performance sound.

The above-described aspects ensure that sound is reproduced with no or minimal delay after receiving the sound through a communication line.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the following figures.

FIG. 1 is a schematic illustrating an ensemble system 1 according to one embodiment.

FIG. 2 is a block diagram illustrating an example configuration of the ensemble system 1 according to the one embodiment.

FIG. 3 illustrates an example of a trained model 120 according to the one embodiment.

FIG. 4 illustrates another example of the trained model 120 according to the one embodiment.

FIG. 5 illustrates another example of the trained model 120 according to the one embodiment.

FIG. 6 is a sequence chart for describing a flow of processing performed by the ensemble system 1 according to the one embodiment.

FIG. 7 is a flowchart of processing performed by a performer terminal 10 according to the one embodiment.

### DESCRIPTION OF THE EMBODIMENTS

The present development is applicable to a first device, an ensemble system, a sound reproducing method, and a non-transitory computer-readable recording medium.

The ensemble system 1 according to the one embodiment will be described by referring to the accompanying drawings. The following description is regarding an example in which remote performers have a session (remote ensemble) using the ensemble system 1. This example, however, is not intended in a limiting sense. It is also possible to use the ensemble system 1 according to the one embodiment to synthesize any other content other than sound.

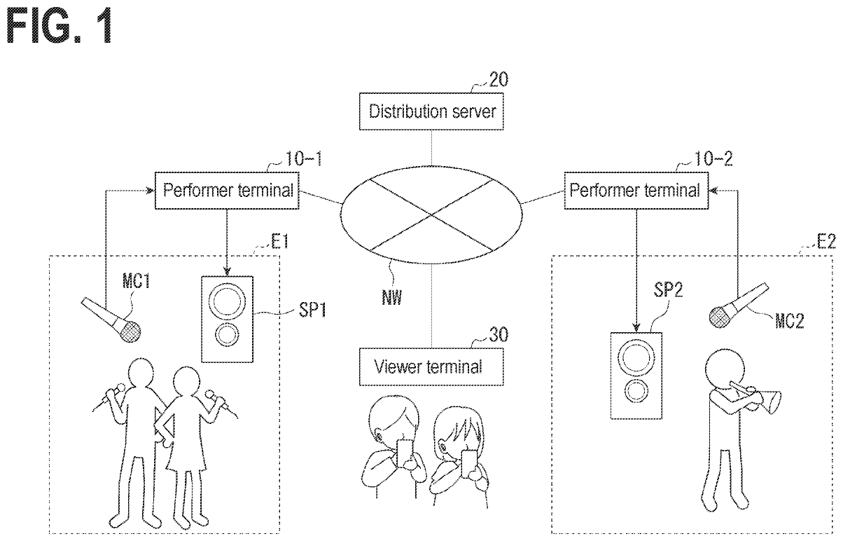

FIG. 1 is a schematic illustrating the ensemble system 1 according to the one embodiment. The ensemble system 1 is a system that transmits, in real-time, a performance sound generated by a performer to other performers located at remote places.

As illustrated in FIG. 1, in the ensemble system 1, a sound of a musical performance in a venue E1 (this sound will be referred to as first performance sound) is obtained by a microphone MC1 and transmitted to a venue E2 through a communication network NW. The venue E2 is a session partner of the venue E1.

In the venue E2, the first performance sound received through the communication network NW is output from a speaker SP2. Also in the venue E2, a performance sound in the venue E2 (this sound will be referred to as second performance sound) is obtained by a microphone MC2 and transmitted to the venue E1 through the communication network NW. Then, in the venue E1, the second performance sound received through the communication network NW is output from a speaker SP1. Also in the ensemble system 1, the first performance sound and the second performance sound are transmitted to and mixed in a distribution server 20, and distributed to a viewer terminal 30 through the distribution server 20.

The ensemble system 1 estimates a future performance sound of the performance sound of the session partner received through the communication network NW. As used herein, the term “future performance sound” is intended to mean a sound generated at a performance time position of T+Δt. The performance time position T+Δt is later in time than the performance time position T of the received performance sound of the session partner.

Specifically, in the venue E1, the second performance sound is received, and a future performance sound of the second performance sound is estimated based on the received second performance sound. In the venue E2, the first performance sound is received, and a future performance sound of the first performance sound is estimated based on the received first performance sound.

To estimate the future performance sounds, trained models are used. Each trained model is a model trained to learn a sound signal corresponding to a performance sound. Each trained model is trained to, upon receipt of a performance sound, estimate a future performance sound of the received performance sound.

Specifically, each trained model is prepared by performing machine learning (for example, deep learning) of a learning model with learning data of sound signals corresponding to performance sounds. Examples of the learning model include a neural network model and an n-ary tree model.

An example of the sound-signal learning data is a sound signal generated based on a sound of a musical instrument obtained using a microphone. The sound signal includes instruction data and time-series data. The instruction data indicates performance content. The time-series data includes a series of time data each indicating a time point at which the instruction data occurs. The instruction data instructs various events such as sound generation and silencing by specifying sound pitch (note number) and strength (velocity). The time data specifies, for example, a time gap (delta time) between one piece of instruction data and another piece of instruction data that is immediately before or after the one piece of instruction data.

In the ensemble system 1, a performance sound received through the communication network NW is input into each trained model. Each trained model estimates and outputs a future performance sound of the input performance sound. The future performance sound estimated by each trained model is output from each speaker.

Specifically, in the venue E1, a second performance sound is received, and the received second performance sound is input into a trained model (second performance sound estimation model). The second performance sound estimation model is a model that is trained to learn a sound signal corresponding to the second performance sound. The second performance sound estimation model estimates a future performance sound of the input second performance sound. The performance sound estimated by the second performance sound estimation model is output from the speaker SP1.

In the venue E2, a first performance sound is received, and the received first performance sound is input into a trained model (first performance sound estimation model). The first performance sound estimation model is a model that is trained to learn a sound signal corresponding to the first performance sound. The first performance sound estimation model estimates a future performance sound of the input first performance sound. The performance sound estimated by the first performance sound estimation model is output from the speaker SP2.

This configuration ensures that a future performance sound of a performance sound received through the communication network NW can be estimated and output in the ensemble system 1 according to the one embodiment. There may be a case where, due to a transmission delay, a performance sound at a performance time position T that is later in time than an actual performance time position (T+Δt) is received. Even in this case, the above configuration ensures that a performance sound at the actual performance time position (T+Δt) can be estimated and output. As a result, a sound received through a communication line can be reproduced with no or minimal delay.

In this respect, the sound-signal learning data used in the learning process may be determined in any convenient manner. The sound-signal learning data may at least be a sound signal corresponding to a performance sound on which an estimation is based. The sound-signal learning data may preferably be a sound performed in a way resembling a performance sound on which an estimation is based. This is because using a performance sound performed in a resembling way in learning increases the accuracy of estimation.

For example, the sound-signal learning data may preferably be a performance sound generated by a performer in a real remote ensemble. The sound-signal learning data may also preferably be a performance sound of a musical instrument actually played in the real remote ensemble. The sound-signal learning data may be, for example, a performance sound generated in a rehearsal (this sound will be referred to as rehearsal sound source). Using a rehearsal sound source ensures that a performance sound can be accurately estimated in the real remote ensemble.

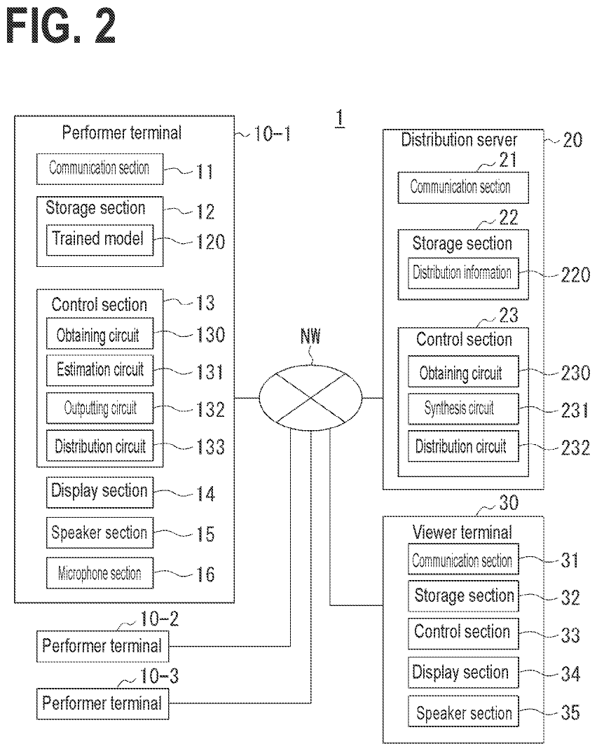

FIG. 2 is a block diagram illustrating an example configuration of the ensemble system 1 according to the one embodiment. In this example, three performer terminals 10-1 to 10-3 conduct a remote performance. This example, however, is not intended in a limiting sense. The ensemble system 1 is applicable in cases where the plurality of performer terminals 10 (performer terminals 10-1 to 10-N; N is a natural number other than one) conduct a remote performance.

As illustrated in FIG. 2, the ensemble system 1 includes the three performer terminals 10-1 to 10-3, the distribution server 20, and the viewer terminal 30. It is to be noted that in the ensemble system 1, a plurality of viewer terminals 30 may be provided.

The performer terminal 10-1 is a computer provided in the venue E1 illustrated in FIG. 1. Examples of the performer terminal 10-1 include a smartphone, a portable terminal, a tablet, and a PC (Personal Computer). The performer terminal 10-1 includes a speaker section 15. The speaker section 15 corresponds to the speaker SP1 illustrated in FIG. 1. The performer terminal 10-1 also includes a microphone section 16. The microphone section 16 corresponds to the microphone MC1 illustrated in FIG. 1.

The performer terminal 10-2 is a computer provided in the venue E2 illustrated in FIG. 1. Examples of the performer terminal 10-2 include a smartphone, a portable terminal, a tablet, and a PC. The performer terminal 10-2 includes a speaker section 15. The speaker section 15 corresponds to the speaker SP2 illustrated in FIG. 1. The performer terminal 10-2 also includes a microphone section 16. The microphone section 16 corresponds to the microphone MC2 illustrated in FIG. 1. The performer terminal 10-3 has a similar configuration, which is omitted in FIG. 1. In the following description, the performer terminals 10-1 to 10-3 will be collectively referred to as “performer terminal 10” where it is not necessary to distinguish the performer terminals 10-1 to 10-3 from each other.

In the ensemble system 1, the performer terminal 10, the distribution server 20, and the viewer terminal 30 are communicatively connected to each other through the communication network NW. An example of the communication network NW is a wide-area network, such as a WAN (Wide Area Network), the Internet, and a combination of a WAN and the Internet.

The performer terminal 10 includes a communication section 11, a storage section 12, a control section 13, a display section 14, the speaker section 15, and the microphone section 16.

The communication section 11 communicates with the distribution server 20. The storage section 12 (which can be a memory) is implemented by a storage medium such as an HDD, a flash memory, an EEPROM (Electrically Erasable Programmable Read Only Memory), a RAM (Random Access read/write Memory), a ROM (Read Only Memory), or a combination of the foregoing. The storage section 12 stores a program for performing various kinds of processing in the performer terminal 10, and stores temporary data used in the various kinds of processing. The storage section 12 stores, for example, the trained model 120. The trained model 120 is information necessary for constructing each trained model. Examples of the information necessary for constructing each trained model include a trained model architecture and setting values of parameters used. In one example, the trained model architecture may be a CNN (Convolutional Neural Network), which includes an input layer, an intermediate layer, and an output layer. In this case, the trained model architecture includes information indicating unit number of each layer, the number of layers of the intermediate layer, and activation function. Parameters used are information indicating coupling coefficients and weights associated with the coupling of the nodes of the layers.

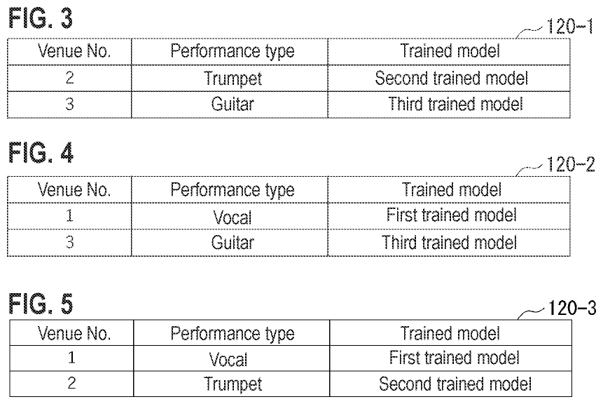

The trained model 120 will be described by referring to FIGS. 3 to 5. FIG. 3 illustrates an example of a trained model 120-1, which is stored in the performer terminal 10-1. FIG. 4 illustrates an example of a trained model 120-2, which is stored in the performer terminal 10-2. FIG. 5 illustrates an example of a trained model 120-3, which is stored in the performer terminal 10-3. In the following description, the trained models 120-1 to 120-3 will be collectively referred to as “trained model 120” where it is not necessary to distinguish the trained models 120-1 to 120-3 from each other.

As illustrated in FIGS. 3 to 5, the trained model 120 includes items such as Venue No., Performance type, and Trained model. Venue No. is identification information, such as number, for uniquely identifying a venue where a performance is carried out. Performance type is information indicating the type of the musical performance carried out in the venue identified by Venue No. An example of Performance type is a musical instrument played. Trained model is a trained model corresponding to the sound of the performance carried out in the venue identified by Venue No.

In the example illustrated in FIG. 3, a second trained model and a third trained model are stored in the trained model 120-1. The second trained model is a model that estimates a future performance sound corresponding to the performance sound of a trumpet played in the venue identified by Venue No. 2. The third trained model is a model that estimates a future performance sound corresponding to the performance sound of a trumpet played in the venue identified by Venue No. 3. It is to be noted that the venue identified by Venue No. 1 corresponds to the venue in which the performer terminal 10-1 is provided. The venue identified by Venue No. 2 or Venue No. 3 corresponds to a venue in which a session partner exists.

In the example illustrated in FIG. 4, a first trained model and a third trained model are stored in the trained model 120-2. The first trained model is a model that estimates a future performance sound corresponding to the performance sound of a trumpet played in the venue identified by Venue No. 1. The third trained model is a model that estimates a future performance sound corresponding to the performance sound of the trumpet played in the venue identified by Venue No. 3. It is to be noted that the venue identified by Venue No. 2 corresponds to the venue in which the performer terminal 10-2 is provided. The venue identified by Venue No. 1 or Venue No. 3 corresponds to a venue in which a session partner exists.

In the example illustrated in FIG. 5, a first trained model and a second trained model are stored in the trained model 120-3. The first trained model is a model that estimates a future performance sound corresponding to the performance sound of the trumpet played in the venue identified by Venue No. 1. The second trained model is a model that estimates a future performance sound corresponding to the performance sound of the trumpet played in the venue identified by Venue No. 2. It is to be noted that the venue identified by Venue No. 3 corresponds to the venue in which the performer terminal 10-3 is provided. The venue identified by Venue No. 1 or Venue No. 2 corresponds to a venue in which a session partner exists.

As illustrated in FIGS. 3 to 5, the trained model 120 stores trained models that estimate performance sounds generated by the session partners.

Referring again to FIG. 1, the control section 13 is implemented by executing a program in CPU (which is a hardware component) of the performer terminal 10. The control section 13 integrally controls the performer terminal 10. Specifically, the control section 13 controls the communication section 11, the storage section 12, the display section 14, the speaker section 15, and the microphone section 16.

The control section 13 includes an obtaining circuit 130, an estimation circuit 131, an outputting circuit 132, and a distribution circuit 133. The obtaining circuit 130 obtains a performance sound of a session partner. The obtaining circuit 130 outputs the obtained performance sound to the estimation circuit 131.

The estimation circuit 131 inputs the performance sound obtained from the obtaining circuit 130 into a trained model to estimate a future performance sound of the performance sound. The estimation circuit 131 outputs the estimated performance sound to the outputting circuit 132.

The outputting circuit 132 causes the speaker section 15 to output the performance sound obtained from the estimation circuit 131. In this manner, the future performance sound of the session partner is emitted from the speaker section 15.

In a case where there are a plurality of session partners, the outputting circuit 132 may mix future performance sounds of the performance sounds of the session partners and output the mixed sound.

The distribution circuit 133 transmits, via the communication section 11, a performance sound obtained by the microphone section 16 to the performer terminal 10 of each session partner and the distribution server 20.

The display section 14 includes a display device such as a liquid crystal display, and is controlled by the control section 13 to display an image, such as a movie, associated with the performance of a session partner. The speaker section 15 is controlled by the control section 13 to output the performance sound of the session partner.

The distribution server 20 is a computer that distributes a movie and/or a sound associated with a musical performance. Examples of the distribution server 20 include a server device, a cloud, and a PC.

The distribution server 20 includes a communication section 21, a storage section 22, and a control section 23. The communication section 21 communicates with each performer terminal 10 and the viewer terminal 30.

The storage section 22 is implemented by a storage medium such as an HDD, a flash memory, an EEPROM, a RAM, a ROM, or a combination of the foregoing. The storage section 22 stores a program for performing various kinds of processing in the distribution server 20, and stores temporary data used in the various kinds of processing.

The storage section 22 stores, for example, distribution information 220. The distribution information 220 is information concerning a distributed sound. Specifically, the distribution information 220 is information indicating distributed content and a list of viewer terminals 30, which are distribution destinations.

The control section 23 is implemented by executing a program in the CPU (which is a hardware component) of the distribution server 20. The control section 23 includes an obtaining circuit 230, a synthesis circuit 231, and a distribution circuit 232.

The obtaining circuit 230 obtains a performance sound from each performer terminal 10. The obtaining circuit 230 outputs, to the synthesis circuit 231, information indicating the obtained each performance sound.

The synthesis circuit 231 generates a synthesized sound (ensemble sound) by mixing the performance sounds obtained from the obtaining circuit 230. For example, the synthesis circuit 231 generates a synthesized sound by compressing the sound sources and adding the compressed sound sources together. The synthesis circuit 231 outputs the generated synthesized sound to the distribution circuit 232.

The distribution circuit 232 distributes the synthesized sound obtained from the synthesis circuit 231 to the viewer terminal 30.

The viewer terminal 30 is a computer of a viewer. Examples of the viewer terminal 30 include a smartphone, a PC, and a tablet terminal. The viewer terminal 30 includes a communication section 31, a storage section 32,a control section 33, a display section 34, and a speaker section 35.

The communication section 31 communicates with the distribution server 20. The storage section 32 is implemented by a storage medium such as an HDD, a flash memory, an EEPROM, a RAM, a ROM, or a combination of the foregoing. The storage section 32 stores a program for performing various kinds of processing in the viewer terminal 30, and stores temporary data used in the various kinds of processing.

The control section 33 is implemented by executing a program in CPU (which is a hardware component) of the viewer terminal 30. The control section 33 integrally controls the viewer terminal 30. Specifically, the control section 33 controls the communication section 31, the storage section 32, the display section 34, and the speaker section 35.

The display section 34 includes a display device such as a liquid crystal display, and is controlled by the control section 33 to display an image, such as a movie, associated with a live remote ensemble.

The speaker section 35 is controlled by the control section 33 to output an ensemble sound of a live remote ensemble.

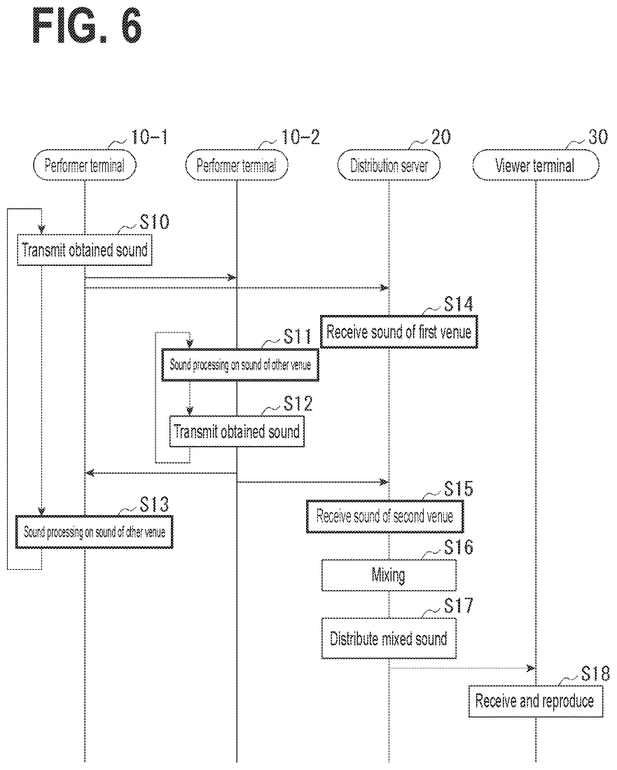

FIG. 6 is a sequence chart for describing a flow of processing performed by the ensemble system 1 according to the one embodiment. The sequence chart illustrates an example in which the two performer terminals 10-1 and 10-2 perform a remote performance.

The performer terminal 10-1 obtains a performance sound generated in the associated venue. Then, the performer terminal 10-1 transmits the obtained performance sound to the performer terminal 10-2 and the distribution server 20 (step S10). The associated venue is the venue where the performer terminal 10-1 is provided.

The performer terminal 10-2 receives a performance sound generated in the other venue, and performs sound processing on the received performance sound of the other venue (step S11). The other venue is the venue where the performer terminal 10-1 is provided. A flow of the sound processing will be described in detail later. The performer terminal 10-2 obtains a performance sound generated in the associated venue, and transmits the obtained performance sound to the performer terminal 10-1 and the distribution server 20 (step S12). The associated venue is the venue where the performer terminal 10-2 is provided. The performer terminal 10-2 repeats steps S11 and S12 until the end of session.

The performer terminal 10-1 receives a performance sound generated in the other venue, and performs sound processing on the received performance sound of the other venue (step S13). The other venue is the venue where the performer terminal 10-2 is provided. The performer terminal 10-1 repeats steps S10 and S13 until the end of session.

The distribution server 20 receives a performance sound generated in a first venue (step S14). The first venue is the venue where the performer terminal 10-1 is provided. The distribution server 20 also receives a performance sound generated in the second venue (step S15). The second venue is the venue where the performer terminal 10-2 is provided. The distribution server 20 mixes the performance sound of the first venue and the performance sound of the second venue (step S16). The distribution server 20 transmits the mixed ensemble sound to the viewer terminal 30 (step S17). The viewer terminal 30 receives the ensemble sound distributed from the distribution server 20, and reproduces the received ensemble sound by outputting the received ensemble sound to the speaker section 35 (step S18).

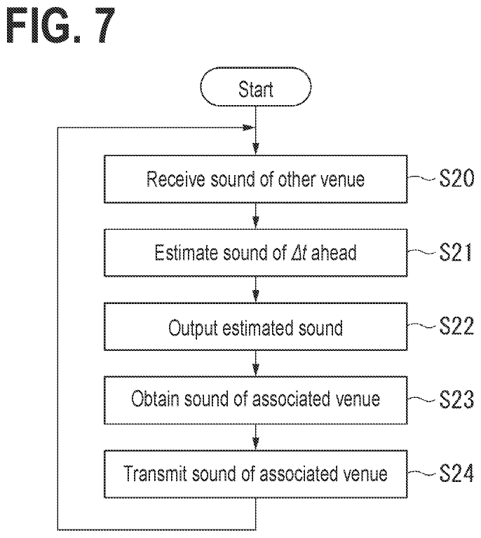

FIG. 7 is a flowchart of sound processing performed by the performer terminal 10 according to the one embodiment. The performer terminal 10 receives a performance sound generated in an other venue (step S20). The performer terminal 10 estimates an performance sound at a performance time position of T+Δt. T+Δt is ahead of the performance time position T of the received performance sound (step S21) by time Δt. The performer terminal 10 outputs the estimated performance sound from the speaker section 15 (step S22). The performer terminal 10 obtains the performance sound of the associated venue using the microphone section 16 (step S23). The performer terminal 10 transmits the performance sound obtained in the associated venue to the performer terminal 10 of each session partner and the distribution server 20 (step S24).

As has been described hereinbefore, the performer terminal 10 according to the one embodiment is provided in the venue E1 when an remote ensemble is performed in the venue E1 and the venue E2. The performer terminal 10 includes the estimation circuit 131. The estimation circuit 131 estimates an estimated future performance sound of a performance sound. The performance sound is a sound obtained by a device (for example, the performer terminal 10-2) provided in the venue E2. The estimation circuit 131 inputs the performance sound into a performance sound estimation model to estimate an estimated performance sound. The performance sound estimation model is a trained model that estimates an estimated performance sound based on the input performance sound. The performance sound estimation model is a trained model trained to learn a sound signal corresponding to the performance sound.

The performer terminal 10 is an example of the “device”. The above-described one embodiment is regarding an example in which the performer terminal 10 provided in the venue E estimates and outputs a performance sound generated in an other venue. This example, however, is not intended in a limiting sense. A performance sound generated in an other venue may be estimated and output by any device insofar as the any device is provided in the venue E. An example of the any device provided in the venue E is a computer such as: a distribution server that distributes an ensemble sound; and a mixer that mixes sounds generated in the venues.

The ensemble system 1 according to the one embodiment the performer terminals 10-1 and 10-2. The performer terminal 10-1 is provided in the venue E1. The performer terminal 10-2 is provided in the venue E2. The performer terminal 10 includes the obtaining circuit 130, the communication section 11, the estimation circuit 131, and the outputting circuit 132. The obtaining circuit 130 of the performer terminal 10-1 obtains a first performance sound generated in the venue E1. The communication section 11 of the performer terminal 10-1 transmits the first performance sound to the performer terminal 10-2. The communication section 11 of the performer terminal 10-1 receives, from the performer terminal 10-2, a second performance sound generated in the venue E2. The estimation circuit 131 of the performer terminal 10-1 estimates a future performance sound (estimated second performance sound) of the second performance sound received by the communication section 11. The estimation circuit 131 estimates the future performance sound using a trained model (second performance sound estimation model). The outputting circuit 132 of the performer terminal 10-1 outputs the estimated sound.

The obtaining circuit 130 of the performer terminal 10-2 obtains the second performance sound generated in the venue E2. The communication section 11 of the performer terminal 10-2 transmits the second performance sound to the performer terminal 10-1. The communication section 11 of the performer terminal 10-2 receives the first performance sound from the performer terminal 10-1. The estimation circuit 131 of the performer terminal 10-2 estimates a future performance sound (estimated first performance sound) of the first performance sound received by the communication section 11. The estimation circuit 131 estimates the future performance sound using a trained model (first performance sound estimation model). The outputting circuit 132 of the performer terminal 10-2 outputs the estimated sound.

The trained model (first performance sound estimation model) is a model that is trained to learn a sound signal corresponding to the performance sound (first performance sound). The trained model (second performance sound estimation model) is a model that is trained to learn a sound signal corresponding to the performance sound (second performance sound). This configuration ensures that a future performance sound of a performance sound received through the communication network NW can be estimated and output in the ensemble system 1 according to the one embodiment. There may be a case where, due to a transmission delay, a performance sound at a performance time position T that is later in time than an actual performance time position (T+Δt) is received. Even in this case, the above configuration ensures that a performance sound at the actual performance time position (T+Δt) can be estimated and output. As a result, a sound received through a communication line can be reproduced with no or minimal delay.

Also in the performer terminal 10 according to the one embodiment, each trained model may be a model trained to learn a sound signal corresponding to a rehearsal sound source. This configuration ensures that a performance sound can be more accurately estimated.

A program for implementing the functions of the processor (the control section 13) illustrated in FIG. 1 may be stored in a computer readable recording medium. The program recorded in the recording medium may be read into a computer system and executed therein. An operation management may be performed in this manner. As used herein, the term “computer system” is intended to encompass hardware such as OS (Operating System) and peripheral equipment.

Also as used herein, the term “computer system” is intended to encompass home-page providing environments (or home-page display environments) insofar as the WWW (World Wide Web) is used. Also, Also as used herein, the term “computer readable recording medium” is intended to mean: a transportable medium such as a flexible disk, a magneto-optical disk, a ROM (Read Only Memory), a CD-ROM (Compact Disk Read Only Memory); and a storage device such as a hard disk incorporated in a computer system. Also as used herein, the term “computer readable recording medium” is intended to encompass a recording medium that holds a program for a predetermined period of time. An example of such recording medium is a volatile memory inside a server computer system or a client computer system. It will also be understood that the program may implement only some of the above-described functions, or may be combinable with a program(s) recorded in the computer system to implement the above-described functions. It will also be understood that the program may be stored in a predetermined server, and that in response to a demand from another device or apparatus, the program may be distributed (such as by downloading) via a communication line.

While embodiments of the present disclosure have been described in detail by referring to the accompanying drawings, the embodiments described above are not intended as limiting specific configurations of the present disclosure, and various other designs are possible without departing from the scope of the present disclosure.

What is claimed is:

1. A first device for a remote ensemble performed in a first venue and a second venue and provided in the first venue, the first device comprising:
a memory configured to store a performance sound estimation model; and
an estimation circuit configured to input, into the performance sound estimation model, a performance sound obtained by a second device provided in the second venue to estimate an estimated future performance sound of the performance sound, the performance sound estimation model comprising a trained model trained to learn a sound signal corresponding to the performance sound to estimate the estimated future performance sound based on the performance sound.

2. The first device according to claim 1, wherein the performance sound estimation model is configured to learn a rehearsal sound source corresponding to the performance sound.

3. An ensemble system for a remote ensemble performed in a first venue and a second venue, the ensemble system comprising:
a first terminal device provided in the first venue; and
a second terminal device provided in the second venue,
the first terminal device comprising:
a first memory configured to store a second performance sound estimation model;
a first obtaining circuit configured to obtain a first performance sound generated in the first venue;
a first transmission circuit configured to transmit the first performance sound to the second terminal device;
a first reception circuit configured to receive, from the second terminal device, a second performance sound generated in the second venue;
a first estimation circuit configured to input, into the second performance sound estimation model, the second performance sound received at the first reception circuit to estimate an estimated future second performance sound of the second performance sound; and
a first sound outputting circuit configured to output the estimated future second performance sound,
the second terminal device comprising:
a second memory configured to store a first performance sound estimation model;
a second obtaining circuit configured to obtain the second performance sound;
a second transmission circuit configured to transmit the second performance sound to the first terminal device;
a second reception circuit configured to receive the first performance sound from the first terminal device;
a second estimation circuit configured to input, into the first performance sound estimation model, the first performance sound received at the second reception circuit to estimate an estimated future first performance sound of the first performance sound; and
a second sound outputting circuit configured to output the estimated future first performance sound,
the first performance sound estimation model comprising a trained model trained to learn a first sound signal corresponding to the first performance sound to estimate the estimated future first performance sound based on the first performance sound, and
the second performance sound estimation model comprising a trained model trained to learn a second sound signal corresponding to the second performance sound to estimate the estimated future second performance sound based on the second performance sound.

4. A sound reproducing method performed by a computer that is for a remote ensemble performed in a first venue and a second venue and that is provided in the first venue, the sound reproducing method comprising:
inputting, into a performance sound estimation model, a performance sound obtained by a device provided in the second venue to estimate an estimated future performance sound of the performance sound, the performance sound estimation model comprising a trained model trained to learn a sound signal corresponding to the performance sound to estimate the estimated future performance sound based on the performance sound.

5. The sound reproducing method according to claim 4, wherein the performance sound estimation model is configured to learn a rehearsal sound source corresponding to the performance sound.

6. A non-transitory computer-readable recording medium storing a program that, when executed by at least one computer that is for a remote ensemble performed in a first venue and a second venue and that is provided in the first venue, cause the at least one computer to perform a method comprising:
inputting, into a performance sound estimation model, a performance sound obtained by a device provided in the second venue to estimate an estimated future performance sound of the performance sound, the performance sound estimation model comprising a trained model trained to learn a sound signal corresponding to the performance sound to estimate the estimated future performance sound based on the performance sound.

7. The non-transitory computer-readable recording medium according to claim 7, wherein the performance sound estimation model is configured to learn a rehearsal sound source corresponding to the performance sound.
